(19) United States
(12) Patent Application Publication
(10) Pub. No.: US 2011/0023074 A1
(43) Pub. Date: Jan. 27, 2011

(54) SYSTEMS AND METHODS FOR FACILITATING ANTENNA CONFIGURATION

(75) Inventor: Phuc H. Nguyen, Highlands Ranch, CO (US)

Correspondence Address: SEED INTELLECTUAL PROPERTY LAW GROUP PLLC, 701 FIFTH AVENUE, SUITE 5400, SEATTLE, WA, 98104, US

(73) Assignee: ECHOSTAR TECHNOLOGIES L.L.C., Englewood, CO (US)

(21) Appl. No.: 12/509,376

(22) Filed: Jul. 24, 2009

(51) Int. Cl. H04N 7/173; H04N 7/16; H04B 17/00; H04M 3/42; G08B 5/22

(52) U.S. Cl. 725/110; 725/151; 455/226.2; 455/414.1; 340/825.36

(57) ABSTRACT

Various embodiments facilitate antenna peaking, such as by assisting a user in configuring the position and/or orientation of an antenna to improve the quality of a received signal. In one embodiment, an antenna peaking system (“APS”) is provided. The APS includes a receiving device, such as a set-top box, and an antenna peaking assistant. The receiving device determines strength of a signal received by an antenna, and transmits information about the determined signal strength to the antenna peaking assistant. The antenna peaking assistant wirelessly receives the transmitted information, and presents an indication of the signal strength. This abstract is provided to comply with rules requiring an abstract, and it is submitted with the intention that it will not be used to interpret or limit the scope or meaning of the claims.

### TECHNICAL FIELD

The technical field relates to antenna peaking, and more particularly, to apparatus, systems and methods for wirelessly receiving and presenting information about antenna signal strength.

### BRIEF SUMMARY

In one embodiment, an antenna peaking system is provided. The system includes a set-top box that is communicatively coupled to an antenna; a display that is communicatively coupled to the set-top box; and a device having a signal strength indicator, the device being in a housing separate from the set-top box and the display and wirelessly communicatively coupled to the set-top box. The set-top box is configured to: determine strength of a program signal received by the antenna; and transmit information about the determined strength of the program signal to the device. The device is configured to: wirelessly receive the transmitted information about the determined strength of the program signal; and present on the signal strength indicator an indication of the strength of the program signal, the presented indication based on the received information.

In another embodiment, a method in a receiving device for facilitating antenna configuration is provided. The method includes: determining strength of a program signal received by an antenna communicatively coupled to a receiving device; and causing an antenna peaking assistant to display an indication of the determined strength of the program signal by: establishing a wireless communication link with the antenna peaking assistant; and transmitting via the wireless communication link information about the determined strength of the program signal.

A method in a hand-held computing device is provided. The method includes: facilitating configuration of an antenna coupled to a receiving device, by: establishing a wireless communication link with the receiving device; receiving from the receiving device information about strength of a signal received from the antenna, the information received via the wireless communication link; and presenting an indication of the strength of the signal, the indication based on the received information.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an example content distribution environment in which embodiments of an antenna peaking system may be implemented.

FIG. 2 is a block diagram illustrating example functional elements of an example embodiment.

FIGS. 3A-3B are block diagrams illustrating example embodiments of an antenna peaking system.

FIG. 4 is a block diagram of a computing system for practicing example embodiments of an antenna peaking system.

FIG. 5 is a flow diagram of an example antenna peaking system process provided by an example embodiment.

FIG. 6 is a flow diagram of an example antenna peaking manager process provided by an example embodiment.

FIG. 7 is a flow diagram of an example antenna peaking assistant process provided by an example embodiment.

### DETAILED DESCRIPTION

A. Environment Overview

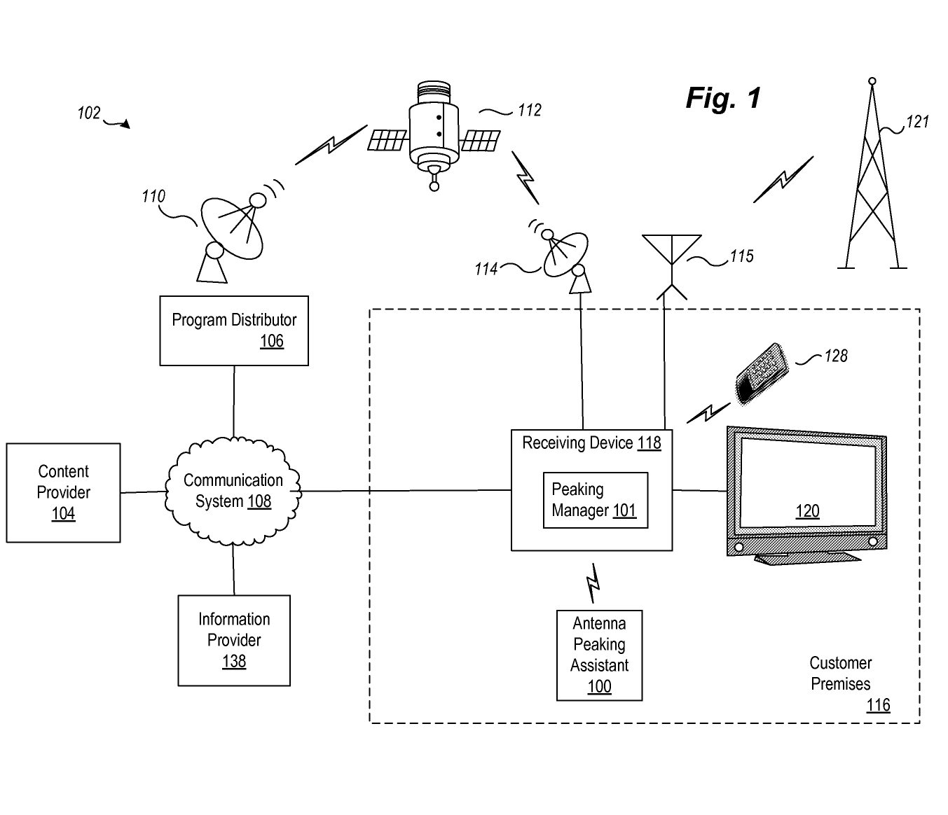

FIG. 1 is an overview block diagram illustrating an example content distribution environment 102 in which embodiments of an Antenna Peaking System (“APS”) may be implemented. “Antenna peaking” refers to the process of configuring an antenna, such as by adjusting the position and/or orientation of an antenna to improve the quality of a signal (e.g., to obtain peak or near-peak signal strength) received by the antenna. The illustrated APS includes an antenna peaking assistant 100 and a peaking manager 101 operating on a receiving device 118. The antenna peaking assistant 100 is a device or component that presents information about the strength of a signal received by antenna 114, the information wirelessly received from the peaking manger 101. A user operating the antenna peaking assistant 100 can view the presented information, and in response, configure the antenna 114 to increase the strength of the received signal. Configuring the antenna 114 may include adjusting, moving, or otherwise altering its position, configuration, and/or orientation, such as its azimuth, elevation, skew, horn distance, low noise block feed (“LNBF”), and the like. Configuring the antenna 114 may also include removing obstructions (e.g., tree branches) from the antenna, cleaning the dish or horn of the antenna, and the like. Before providing additional details regarding the APS, the content distribution environment 102 in which the APS operates will briefly be described.

In the content distribution environment 102, audio, video, and/or data service providers, such as, but not limited to, television service providers, provide their customers a multitude of audio/video and/or data programming (hereafter, collectively and/or exclusively “programming”). Such programming is often provided by use of a receiving device 118 communicatively coupled to a presentation device 120 configured to receive the programming.

The receiving device 118 interconnects to one or more communications media or sources (such as a cable head-end, satellite antenna, telephone company switch, Ethernet portal, off-air antenna, or the like) that provide the programming. The receiving device 118 commonly receives a plurality of programming by way of the communications media or sources described in greater detail below. Based upon selection by a user, the receiving device 118 processes and communicates the selected programming to the presentation device 120.

For convenience, the receiving device 118 may be interchangeably referred to as a “television converter,” “receiver,” “set-top box,” “television receiving device,” “television receiver,” “television recording device,” “satellite set-top box,” “satellite receiver,” “cable set-top box,” “cable receiver,” “media player,” and/or “television tuner.” Accordingly, the receiving device 118 may be any suitable converter device or electronic equipment that is operable to receive programming. Further, the receiving device 118 may itself include user interface devices, such as buttons or switches. In many applications, a remote-control device (“remote”) 128 is operable to control the receiving device 118 and/or the presentation device 120. The remote 128 typically communicates with the receiving device 118 using a suitable wireless medium, such as infrared (“IR”), radio frequency (“RF”), or the like.

Examples of a presentation device 120 include, but are not limited to, a television (“TV”), a personal computer (“PC”), a sound system receiver, a digital video recorder (“DVR”), a compact disk (“CD”) device, game system, or the like. Presentation devices 120 employ a display, one or more speakers, and/or other output devices to communicate video and/or audio content to a user. In many implementations, one or more presentation devices 120 reside in or near a customer's premises 116 and are communicatively coupled, directly or indirectly, to the receiving device 118. Further, the receiving device 118 and the presentation device 120 may be integrated into a single device. Such a single device may have the above-described functionality of the receiving device 118 and the presentation device 120, or may even have additional functionality.

A content provider 104 provides program content, such as television content or audio content, to a distributor, such as the program distributor 106. Example content providers include television stations which provide local or national television programming, special content providers which provide premium based programming or pay-per-view programming, or radio stations which provide audio programming.

Program content, interchangeably referred to as a program, is communicated to the program distributor 106 from the content provider 104 through suitable communication media, generally illustrated as communication system 108 for convenience. Communication system 108 may include many different types of communication media, now known or later developed. Non-limiting media examples include telephony systems, the Internet, internets, intranets, cable systems, fiber optic systems, microwave systems, asynchronous transfer mode (“ATM”) systems, frame relay systems, digital subscriber line (“DSL”) systems, radio frequency (“RF”) systems, and satellite systems.

In at least one embodiment, the received program content is converted by the program distributor 106 into a suitable signal (a “program signal”) that is communicated (i.e., “uplinked”) by one or more antennas 110 to one or more satellites 112 (separately illustrated herein from, although considered part of, the communication system 108). The communicated uplink signal may contain a plurality of multiplexed programs. The uplink signal is received by the satellite 112 and then communicated (i.e., “downlinked”) from the satellite 112 in one or more directions, for example, onto a predefined portion of the planet.

A receiver antenna 114 that is within reception range of the downlink signal communicated from satellite 112 receives the above-described downlink signal. A wide variety of receiver antennas 114 are available. Some types of receiver antenna 114 are operable to receive signals from a single satellite 112. Other types of receiver antenna 114 are operable to receive signals from multiple satellites 112. In addition, in some embodiments, a terrestrial “over the air” (“OTA”) broadcast antenna 115 is configured to receive a program signal from a terrestrial based transmitter, such as broadcast transmit tower 121.

The receiver antennas 114-115 can be located at customer premises 116. Examples of customer premises 116 include a residence, a business, or any other suitable location operable to receive signals from satellite 112. The received signal is communicated, typically over a hard-wire connection, to a receiving device 118. The receiving device 118 converts the received signal from antennas 114-115 into a signal and/or format suitable for communication to a presentation device 120 or another device, such as a digital video recorder or a home computing system. In some embodiments, the receiver antennas 114-115 may be remotely located from the customer premises 116. For example, the antennas 114-115 may be located on the roof of an apartment building, such that the received signals may be transmitted, after possible recoding, via cable or other mechanisms, such as Wi-Fi, to the customer premises 116.

The receiving device 118 may receive programming partially from, or entirely from, another source other than the above-described receiver antennas 114-115. Other embodiments of the receiving device 118 may receive programming from program distributors 106 and/or content providers 104 via cable, fiber optic, Internet media, or the like.

In addition, information provider 138 may provide various forms of content and/or services to various devices residing in the customer premises 116. For example, information provider 138 may provide a Web page (or other information) to the receiving device 118 or other computing device. Information provider 138 may further perform or facilitate electronic commerce transactions.

In the illustrated example, the Antenna Peaking System (“APS”) includes an antenna peaking assistant 100 and peaking manager 101 operating upon the receiving device 118. The antenna peaking assistant 100 is typically a hand-held computing device in a housing that includes a self-contained power source (e.g., a battery) and a signal strength indicator. The antenna peaking assistant 100 is typically dimensioned such that it is easily portable in a hand, pocket, or luggage of a user.

The antenna peaking assistant 100 is further configured to communicate wirelessly with the peaking manager 101 of the receiving device 118. The peaking manager 101 determines the strength of a program signal received by the antennas 114-115, and transmits information about the determined signal strength to the antenna peaking assistant 100. The antenna peaking assistant 100 wirelessly receives the transmitted information, and presents an indication of the strength of the program signal on the signal strength indicator. Wirelessly receiving the transmitted information may be accomplished using one or more suitable protocols and/or media, including using a cellular network, a wireless local area network (“WLAN”), a wireless personal area network (“WPAN”), WiFi, Long Term Evolution (“LTE”), WiMAX, infrared communication, and the like.

In one embodiment, described further with respect to 3A below, the antenna peaking assistant 100 is a cellular telephone having a bit-mapped graphics display. The cellular telephone communicates via a cellular telephone network with the peaking manager 101, and displays a graphical signal meter or other indicator upon its bit-mapped graphics display.

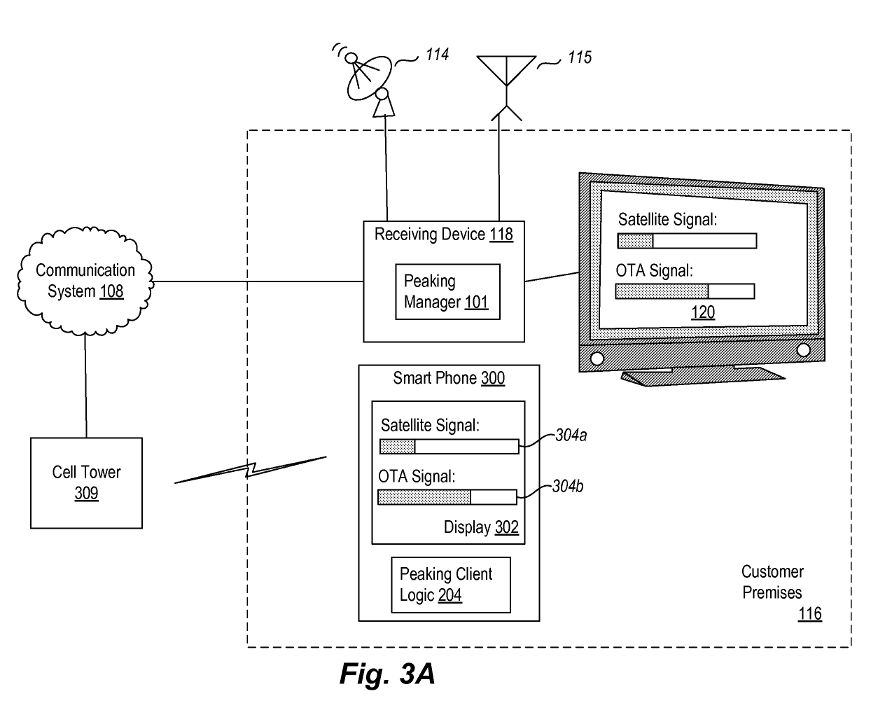

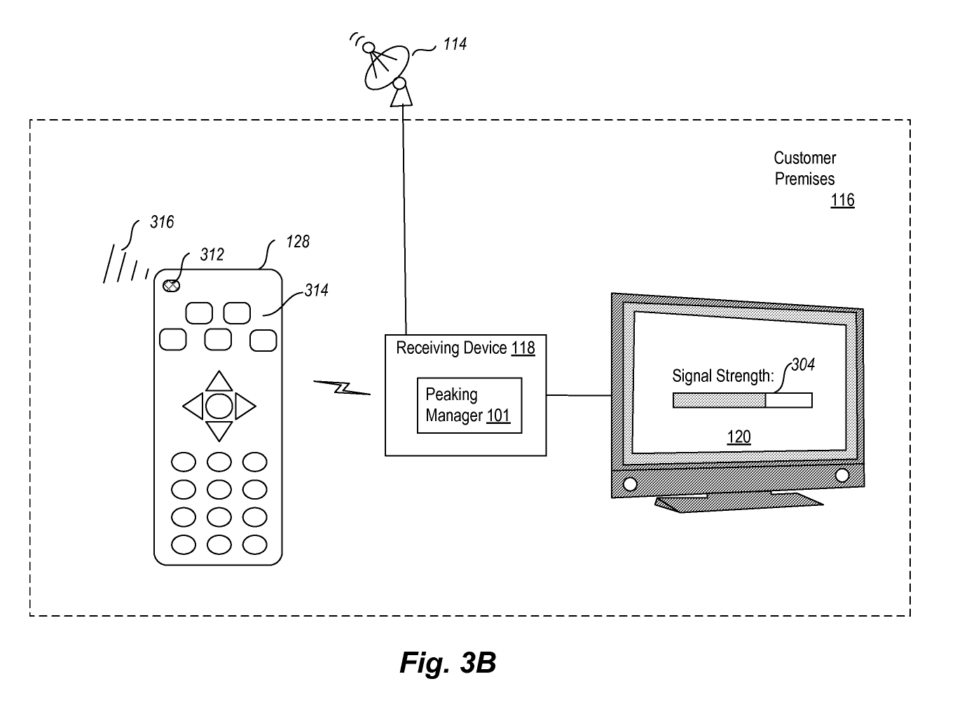

In another embodiment, described further with respect to FIG. 3B below, the antenna peaking assistant 100 is a remote-control device having illuminated buttons and/or a speaker. The remote-control device is configured to control various functions of the receiving device 118, in addition to wirelessly communicate with the peaking manager 101. Upon receiving information about the antenna signal strength, the remote-control device indicates the strength of the signal by increasing illumination of one or more buttons and/or modifying a tone output via its speaker.

In a further embodiment, the antenna peaking assistant 100 is a personal digital assistant (“PDA”) that communicates with the peaking manager 101 via a wireless local area network. Other embodiments are contemplated, such as ones resident on a personal media player, a personal computer (e.g., a laptop or netbook computer), or the like.

The above description of the content distribution environment 102 and the customer premises 116, and the various devices therein, is intended as a broad, non-limiting overview of an example environment in which various embodiments of an antenna peaking system may be implemented. FIG. 1 illustrates just one example of a content distribution environment 102 and that the various embodiments discussed herein are not limited to such environments. In particular, content distribution environment 102 and the various devices therein, may contain other devices, systems and/or media not specifically described herein.

Example embodiments described herein provide applications, tools, data structures and other support to implement an antenna peaking system that facilitates improved positioning and/or orientation of an antenna. Other embodiments of the described techniques may be used for other purposes, including for signal quality monitoring generally. In the following description, numerous specific details are set forth, such as data formats, code sequences, and the like, in order to provide a thorough understanding of the described techniques. The embodiments described also can be practiced without some of the specific details described herein, or with other specific details, such as changes with respect to the ordering of the code flow, different code flows, and the like. Thus, the scope of the techniques and/or functions described are not limited by the particular order, selection, or decomposition of steps described with reference to any particular module, component, or routine.

B. Example Antenna Peaking System Overview

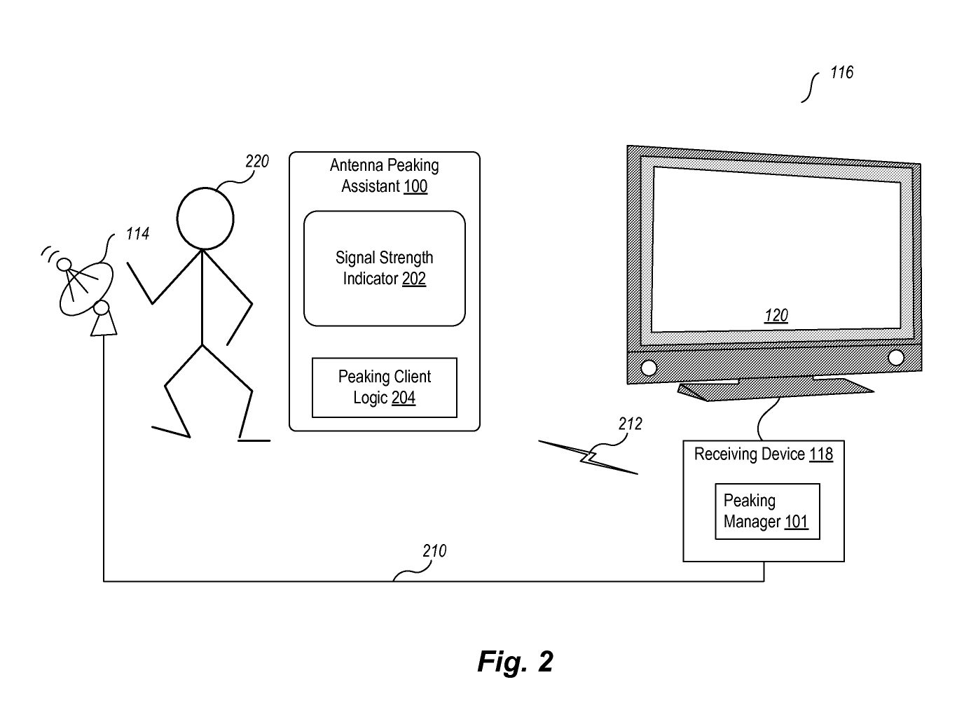

FIG. 2 is a block diagram illustrating example functional elements of an example embodiment. In particular, FIG. 2 shows an example antenna peaking system in a customer premises 116, including the antenna peaking assistant 100 operated by a user 220, a receiving device 118 such as a set-top box, a presentation device 120 such as a television display, and an antenna 114. The antenna peaking assistant 100 includes a signal strength indicator 202 and peaking client logic 204. The antenna peaking assistant 100 is communicatively coupled to the receiving device 118 via wireless link 212. The receiving device includes a peaking manager 101 and is communicatively coupled via link 210 to the antenna 114.

The peaking manager 101 is configured to determine strength of a signal received by the antenna 114 and transmitted to the receiving device 118. In one embodiment, determining signal strength includes measuring the strength of the signal received via link 210 by the receiving device 118 from the antenna 114. Signal strength may be measured in various ways, such as by measuring the magnitude of an analog or digital representation of the signal received by the receiving device 118 via link 210. In another embodiment, the peaking manager 101 receives indications of the strength of the signal measured by some other component of the receiving device 118 or the antenna 114 itself.

The peaking manager 101 is further configured to transmit information about the determined signal strength to the antenna peaking assistant 100. The transmitted information may be or include, for example, a numeric representation of the determined signal strength (e.g., expressed in dBV, dBm, dBm per meter, or other suitable units).

The peaking client logic 204 of the antenna peaking assistant 100 is configured to wirelessly receive the transmitted signal strength information from the peaking manager 101. Wirelessly receiving the transmitted information may include the use of various communication protocols, standards, and/or media, such as wireless local/personal area network standards, cellular telephony, radio-frequency transmission, infrared, and the like. In one embodiment, the peaking client logic 204 receives the transmitted information via a voice and/or data channel provided by a cellular telephone network. In another embodiment, the peaking client logic 204 receives the transmitted information via a wireless LAN (not shown) deployed in the customer premises.

The peaking client logic 204 is further configured to format and present an indication of the strength of the signal on the signal strength indicator 202. In one embodiment, the signal strength indicator 202 includes a graphics display, such as the display of a cellular telephone, smart phone, personal digital assistant, or other hand-held computing device. In another embodiment, the signal strength indicator 202 includes one or more light sources, such as LED bulbs or illuminated buttons of a keypad of a remote-control device or cellular telephone. In a further embodiment, the signal strength indicator 202 includes an audio output device, such as a speaker of a cellular telephone, remote-control device, PDA, digital music player, and the like.

The communication link 212 between the peaking manager 101 and the peaking client logic 204 can be established in various ways. In one embodiment, the peaking client logic 204 initiates establishment of the communication link 212 by initiating a TCP (“Transmission Control Protocol”) session with the peaking manager 101. In another embodiment, the peaking manager 101 initiates establishment of the communication link 212 by placing a telephone call to the antenna peaking assistant 100. In other embodiments, “session-less” approaches may be used, such as by transmitting messages and/or packets without first establishing a logical session or other type of persistent link. In such cases, a datagram protocol, such as UDP, may be employed, in which the peaking manager 101 simply transmits the information in a network packet addressed to the antenna peaking assistant 100 and/or some broadcast address.

Various schemes may be employed to govern the transmission of signal strength information between the peaking manger 101 and the peaking client logic 204. In a “pull” model, the peaking client logic 204 pulls signal strength information from the peaking manager 101 by transmitting a request for the signal strength information to the peaking manager 101. In a “push” model, the peaking manager 101 pushes signal strength information to the peaking client logic 204 without awaiting a specific request for the signal strength information.

Typically, signal strength information is repeatedly determined and transmitted by the peaking manager 101, such that the peaking client logic 204 can provide a substantially real-time presentation of the received signal strength information. As one example, the peaking manager 101 measures and transmits signal strength information every second. In another example, the peaking manager 101 measures and transmits signal strength information only when a specified time interval (e.g., five seconds) has elapsed and the signal strength information has changed from the most recent transmission.

In a typical situation, the user 220, the antenna 114, and the antenna peaking assistant 100 are situated together and remote from the receiving device 118. For example, the user 220 holds the antenna peaking assistant 100, while standing on a roof of the customer premises 116 and while configuring the antenna 114. Then, the user 220 can interactively configure the position and/or orientation one of the antenna 114, and receive feedback via the signal strength indicator 202 regarding the effectiveness of the adjusted antenna configuration. In this manner, the user 220, acting without assistance of another person, can determine the effectiveness adjustments made to the antenna 114. As another advantage, the user 220 does not need to carry an additional device, such as a signal strength meter, because the antenna peaking assistant 100 may be a smart phone, PDA, remote-control, or other device that the user 220 ordinarily has in his or her possession (or is otherwise readily available at the customer premises 116).

Note that although the embodiments described herein are discussed primarily with reference to signal strength, other signal characteristics (e.g., signal energy, frequency, and/or amplitude) may be utilized as an indicator of signal quality.

C. Example Antenna Peaking Assistants

FIGS. 3A-3B are block diagrams illustrating example embodiments of an antenna peaking system. In particular, FIGS. 3A and 3B respectively illustrate embodiments in which a smart phone and a remote-control device are configured to operate as antenna peaking assistants.

In the embodiment of FIG. 3A, the antenna peaking system includes a smart phone 300 configured to act as an antenna peaking assistant and a peaking manager 101 operating on a receiving device 118. The receiving device 118 is coupled to a presentation device 120 as well as antennas 114-115. Antenna 114 is configured to receive a satellite-transmitted program signal. Antenna 115 is configured to receive a terrestrial over-the-air (“OTA”) program signal. The smart phone 300 includes peaking logic 204 and a touch-sensitive display 302 configured to receive user inputs and provide graphical output. A separate keypad may be included instead of, or in addition to, the touch-sensitive display 302.

In FIG. 3A, the peaking manager 101 establishes a communication link with the smart phone 300 by placing a telephone call to the smart phone 300. The telephone call is placed via the communication system 108, where the telephone call is routed via cell tower 309 to the smart phone 300. The smart phone 300 receives (e.g., picks up) the telephone call and uses the received call to provide a communication link from the peaking client logic 204 to the peaking manager 101. Other types of communication links between the smart phone 300 and the receiving device 118 are contemplated, such as a WiMAX or LTE link to the communication system 108, a wireless local/personal area network link to the receiving device 118, or the like. Any suitable technique (e.g., media, protocol, etc.) can be utilized to communicate between the receiving device 118 and the smart phone 300 or other type of antenna peaking assistant.

Once the communication link between the peaking manager 101 and the peaking client logic 204 is established, the peaking manager 101 transmits signal strength information to the peaking client logic 204. The peaking client logic 204 receives the transmitted information, and initiates presentation of signal strength meters 304a and 304b on the display 302. The signal strength meters 304a and 304b respectively indicate the strength of the program signal received by antennas 114-115. Each signal strength meter 304a and 304b indicates signal strength by way of a bar having a length that increases with the strength of the corresponding received program signal. Other types of signal strength meters are contemplated, such as ones including a numeric readout (e.g., as a percentage of a maximum or in units of signal power), an arrow and dial display, and the like. In addition, the signal strength meters can be annotated with additional information, such as satellite name and/or position, terrestrial broadcast station name/frequency, or the like.

The peaking manager 101 transmits updated signal strength information from time to time. In particular, the peaking manager 101 repeatedly determines the strength of the signals received by antennas 114-115 and transmits that information, such that the peaking client logic 204 can update the signal strength meters 304a and 304b in a substantially real-time manner. Then, a user operating the smart phone 300 can interactively configure the position and/or orientation one of the antennas 114-115, and receive feedback via the appropriate signal strength meter 304 regarding the effectiveness of the adjusted antenna configuration.

In the embodiment of FIG. 3B, the antenna peaking system includes a remote-control device 128 configured to act as an antenna peaking assistant and a peaking manager 101 operating on a receiving device 118. The receiving device 118 is coupled to a presentation device 120 as well as antenna 114. Antenna 114 is configured to receive a satellite-transmitted program signal. The remote-control device (“remote”) 128 includes peaking client logic (not shown), a speaker 312, and a keypad 314 comprising multiple buttons. At least some of the buttons are illuminated, such as with an LED backlight, or other suitable light source. In some embodiments, the remote 128 includes a display, such as a bit-mapped graphics display, that can be used to provide additional information, such as antenna identifier (e.g., satellite or OTA antenna), satellite identifier, broadcast station name, and the like.

In FIG. 3B, the peaking manager 101 and the remote 128 communicate using a communication link established via a wireless personal area network (“WPAN”). In one embodiment, the communication link is established using radio frequency (“RF”) signals according to the ZigBee protocol. Other communication techniques/media are contemplated, including using other transmission spectra, such as infrared (“IR”), or other communication standards, such as Bluetooth.

Once the communication link between the peaking manager 101 and the peaking client logic of the remote 128 is established, the peaking manager 101 transmits signal strength information to the client logic. The client logic receives the transmitted information, and indicates the strength of the program signal received by antenna 114 as measured at the receiving device 118. In particular, the client logic outputs a tone via the speaker 312, the frequency of which increases with the strength of the program signal, such that a higher frequency tone indicates a stronger signal. Other properties/characteristics of the tone may be varied to indicate program signal strength, including increasing/decreasing the volume of the tone.

In addition, the client logic adjusts illumination of one or more of the illuminated buttons of the keypad 314. In one configuration, the client logic illuminates a number of buttons corresponding to the strength of the signal, such that a stronger signal results in a greater number of illuminated buttons. In another configuration, the client logic increases the illumination level of one or more buttons, such that brighter buttons indicate a stronger signal. Other techniques for indicating signal strength are contemplated, including altering illumination color, numeric and/or graphical readouts, and the like.

Typically, the audio and visual output provided by the client logic is synchronized. In particular, in the presence of a strengthening signal, the frequency of the tone is increased concurrently with increases in the illumination of the one or more illuminated buttons. In addition, in the presence of a weakening signal, the frequency of the tone is decreased concurrently with decreases in the illumination of the one or more illuminated buttons.

As discussed with respect to FIG. 3A, the peaking manager 101 transmits updated signal strength information from time to time, such that the peaking client logic 204 can update the signal strength meters 304a and 304b in a substantially real-time manner.

D. Example Computing System Implementation

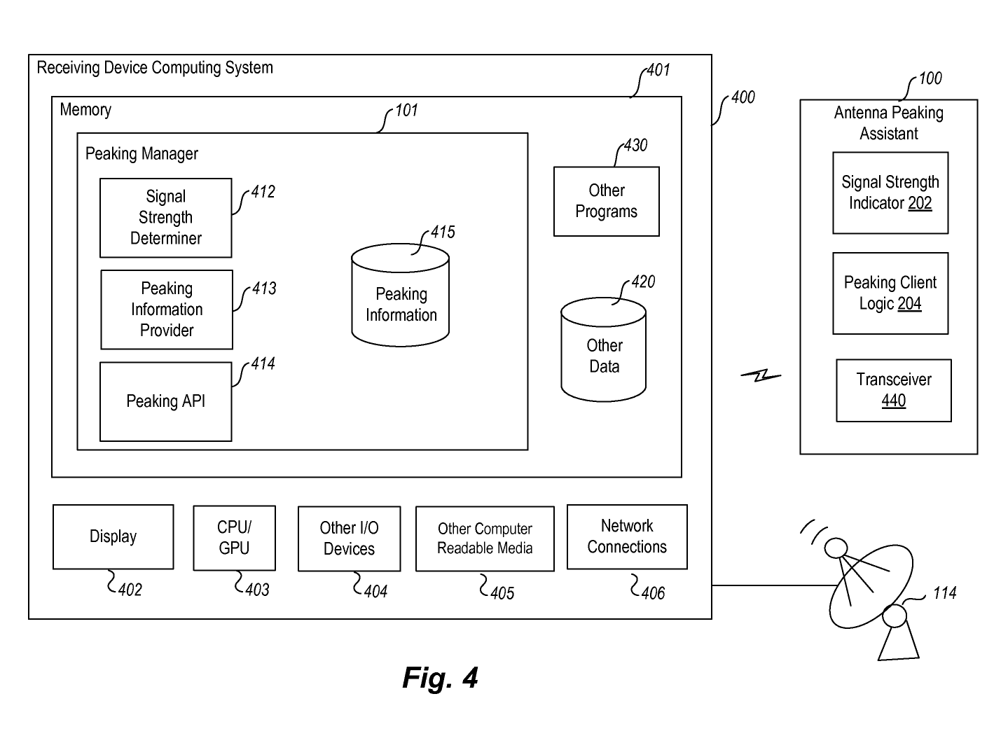

FIG. 4 is a block diagram of a computing system for practicing example embodiments of an antenna peaking system. As shown in FIG. 4, the described antenna peaking system (“APS”) includes an antenna peaking assistant 100 and a receiving device computing system 400 having an antenna peaking manager 101. In one embodiment, the receiving device computing system 400 is part of a set-top box or other receiving device configured to receive and display programming on a presentation device. Note that the computing system 400 may comprise one or more distinct computing systems/devices and may span distributed locations. Furthermore, each block shown may represent one or more such blocks as appropriate to a specific embodiment or may be combined with other blocks. Also, components of the APS, such as the peaking manager 101 and peaking client logic 204 may be implemented in software, hardware, firmware, or in some combination to achieve the capabilities described herein.

In the embodiment shown, receiving device computing system 400 comprises a computer memory (“memory”) 401, a display 402, one or more Central/Graphical Processing Units (“CPU/GPU”) 403, Input/Output devices 404 (e.g., keyboard, mouse, CRT or LCD display, and the like), other computer-readable media 405, and network connections 406. The peaking manager 101 is shown residing in memory 401. In other embodiments, some portion of the contents, some of, or all of the components of the peaking manager 101 may be stored on and/or transmitted over the other computer-readable media 405. The components of the peaking manager 101 preferably execute on one or more CPUs 403 and facilitate antenna peaking, as described herein. Other code or programs 430 (e.g., an audio/video processing module, an electronic program guide manager module, a Web server, and the like) and potentially other data repositories, such as data repository 420 (e.g., including stored programming), also reside in the memory 401, and preferably execute on one or more CPUs 403. The computing system 400 is communicatively coupled to antenna 114, which receives a program signal from a satellite transponder or some other (e.g., terrestrial) source. Of note, one or more of the components in FIG. 4 may not be present in any specific implementation. For example, some embodiments may not include a display 402, and instead utilize a display provided by another media device, such as a presentation device 120.

The antenna peaking assistant 100 includes a signal strength indicator 202, peaking client logic 204, and a transceiver 440. The signal strength indicator 202 may include a display, a speaker, a light, or any other element suitable for indicating the relative or absolute strength of a program signal. The peaking client logic 204 performs the core peaking functions of the antenna peaking assistant 100. In particular, the peaking client logic 204 receives, via transceiver 440 and from the peaking manager 101, information about the strength of a program signal received by antenna 114. In addition, the peaking client logic 204 configures the signal strength indicator 202 to indicate the strength of the received program signal. The antenna peaking assistant 100 may include other components that are not illustrated here. For example, the antenna peaking assistant 100 may include a keypad or other input device, so that a user can provide input to the peaking client logic 204, such as to make various user interface selections, such as adjusting display settings, specifying information sources, selecting particular antennas, and the like. Furthermore, the antenna peaking assistant 100 typically includes a CPU and other components of a computing system (such as those described with respect to computing system 400) that are not shown for the sake of clarity.

In at least some embodiments, a user initially configures the antenna peaking assistant 100 by obtaining and installing the peaking client logic 204. For example, when the antenna peaking assistant 100 is a smart phone or PDA, the user may download a software program/module containing the peaking client logic 204, and install the downloaded module in a memory of the antenna peaking assistant 100. The module may be downloaded from various sources, including the peaking manager 101, the program distributor 106 (FIG. 1), or some third party source.

In a typical embodiment, the peaking manager 101 includes a signal strength determiner 412, a peaking information provider 413, a peaking application program interface (“API”) 414, and a data repository 415 that includes peaking information. Other and/or different modules may be implemented.

The signal strength determiner 412 measures or otherwise determines strength of a program signal received by antenna 114. The signal strength determiner 412 stores information about the determined signal strength in the data repository 415, for use by other components, such as the peaking information provider 413 and/or the peaking API 414.

The peaking information provider 413 transmits signal strength information to the antenna peaking assistant 100. In one embodiment, the peaking information provider 413 implements the server portion of a client-server system, by responding to requests received from the antenna peaking assistant 100 for signal strength information. In another embodiment, the peaking information provider 413 periodically broadcasts, to a specified broadcast address/port, signal strength information, so that it can be obtained by any device configured to receive data at the specified broadcast address. In another embodiment, the peaking information provider 413 establishes a communication link to the antenna peaking assistant 100, such as by initiating a telephone call, opening a network connection, or the like.

The peaking API 414 provides programmatic access to one or more functions of the peaking manager 101. For example, the peaking API 414 may provide a programmatic interface to one or more antenna peaking functions of the peaking manger 101 that may be invoked by one of the other programs 430 or some other module. In this manner, the peaking API 414 may facilitate the development of third-party software, such as user interfaces, plug-ins, adapters (e.g., for integrating functions of the peaking manager 101 into desktop applications), and the like.

In addition, the peaking API 414 may be in at least some embodiments invoked or otherwise accessed via remote entities, such as a home computing system or a program distributor 106, to access antenna peaking functionality of the peaking manager 101. For example, the program distributor 106 described with respect to FIG. 1 may access the peaking API 414 to remotely monitor a customer's antenna signal strength, so as to detect degraded antenna signal quality and in response, initiate a customer service/assistance contact to rectify the condition.

The data repository 415 records peaking information that is used by the peaking manager 101 and/or provided to the antenna peaking assistant 100. Peaking information may include signal strength measurements, antenna information, system configuration information, and the like. Signal strength measurements may be represented as records in a table or database, each record including an antenna identifier, a timestamp, a strength level, and/or other types of information about a particular measurement. Antenna information includes information about one or more antennas coupled to the computing system 400, such as antenna names (e.g., identifier), types, characteristics, and the like. System configuration information may include operational settings, such as how frequently to transmit updated signal strength information, preferred network addresses/ports, security settings, and the like. In some embodiments, the peaking information may also include peaking client logic modules, such that the peaking manager 101 can provide a peaking client logic module to a remote device, such as a smart phone or PDA, so that the remote device can operate as an antenna peaking assistant.

In an example embodiment, components/modules of the peaking manager 101 and the peaking client logic 204 are implemented using standard programming techniques. For example, the peaking client logic 204 may be implemented as a sequence of “native” instructions executing on a CPU (not shown) of the antenna peaking assistant 100. In addition, the peaking manager 101 may be implemented as a native executable running on the CPU 403, along with one or more static or dynamic libraries. In other embodiments, the peaking manager 101 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), declarative (e.g., SQL, Prolog, and the like).

The embodiments described above may also use well-known or proprietary synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported by an APS implementation. Also, other functions could be implemented and/or performed by each component/module, and in different orders, and by different components/modules, yet still achieve the functions of the APS.

In addition, programming interfaces to the data stored as part of the peaking manager 101, such as in the data repository 415, can be available by standard mechanisms such as through C, C++, C#, and Java APIs; libraries for accessing files, databases, or other data repositories; through scripting languages such as XML; or through Web servers, FTP servers, or other types of servers providing access to stored data. The data repository 415 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of an APS.

Furthermore, in some embodiments, some or all of the components of the peaking manager 101 and/or the peaking client logic 204 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

E. Processes

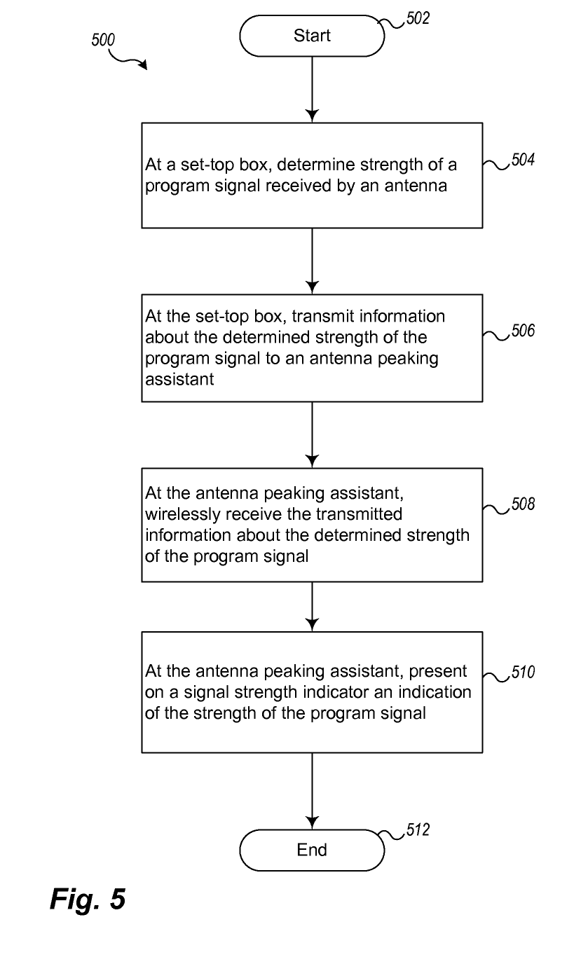

FIGS. 5-7 are flow diagrams of example processes provided by example embodiments. In particular, FIGS. 5-7 are flow diagrams of example processes for an antenna peaking system, a peaking manager, and an antenna peaking assistant, respectively.

FIG. 5 is a flow diagram of an example antenna peaking system process provided by an example embodiment. In particular, FIG. 5 illustrates process 500 that may be implemented by, for example, one or more modules/components of the peaking manager 101 operating on a set-top box, and peaking client logic 202 operating on an antenna peaking assistant 100, as described with respect to FIGS. 2 and 4.

The illustrated process 500 starts at 502. At 504, at the set-top box, the process determines strength of a program signal received by an antenna. As noted above, determining strength of the program signal may include measuring the power or strength of a signal received by an antenna that is communicatively coupled to the set-top box. In other embodiments, determining the strength of the program signal includes receiving information about the strength of a received signal, as measured by some other component (e.g., of the set-top box or of the antenna itself).

At 506, at the set-top box, the process transmits information about the determined strength of the program signal to an antenna peaking assistant. The transmitted information may be or include a number or some other indication of the determined signal strength (e.g., a number between 0 and 100, expressing a percentage of a predetermined maximum signal strength; a number measuring power in dB ratio, dBm, dBuV, or the like). The transmitted information may also include other information, such as the compass position/orientation (e.g., in degrees) of the antenna, or an antenna identifier, which can be used to distinguish multiple antennas that may be coupled to the set-top box.

At 508, at the antenna peaking assistant, the process wirelessly receives the transmitted information about the determined strength of the program signal. As noted, the antenna peaking assistant can wirelessly receive the transmitted information in various ways, such as via a public or private wireless local or personal area network, a cellular telephone network, and the like.

At 510, at the antenna peaking assistant, the process presents on a signal strength indicator an indication of the strength of the program signal. The signal strength indicator may be or include a graphics display, one or more light sources, a speaker, or the like, as discussed with respect to FIGS. 3A and 3B. In addition, the signal strength indicator may include identifying information about the received program signal, such as satellite name/position, terrestrial broadcast channel/station, frequency, and the like.

At 512, the process ends. In other embodiments, the process may instead continue to one of steps 504-510 in order to present updated information about the strength of the program signal received by the antenna.

Some embodiments perform one or more operations/aspects in addition to the ones described with respect to process 500. For example, in one embodiment, process 500 displays, concurrently with the transmission of signal strength information, an indication of the determined signal strength upon a television or other display device coupled to the set-top box.

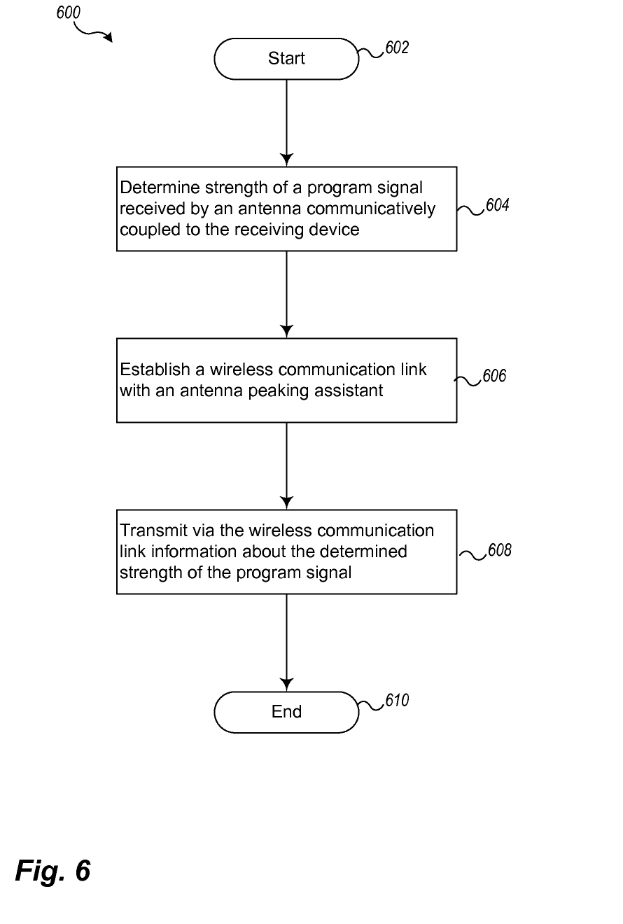

FIG. 6 is a flow diagram of an example antenna peaking manager process provided by an example embodiment. In particular, FIG. 6 illustrates process 600 that may be implemented by, for example, one or more modules/components of the peaking manager 101 operating on a receiving device 118, as described with respect to FIGS. 2 and 4.

The illustrated process 600 starts at 602. At 604, the process determines strength of a program signal received by an antenna communicatively coupled to the receiving device.

At 606, the process establishes a wireless communication link with an antenna peaking assistant. As discussed with respect to FIG. 2, establishing a wireless communication link with the antenna peaking assistant may include establishing a network connection via a wireless personal or local area network, a voice/data channel of a cellular telephone network, or the like.

At 608, the process transmits via the wireless communication link information about the determined strength of the program signal. Various approaches for transmitting information about the determined signal strength are discussed with respect to FIG. 2, above.

At 610, the process ends. In other embodiments, the process may instead continue to one of steps 604-608 in order to provide to the antenna peaking assistant updated information about the strength of the program signal received by the antenna, such that a user of the antenna peaking assistant can receive continuous feedback regarding his or her antenna configuration adjustments in substantially real-time.

Some embodiments perform one or more operations/aspects in addition to the ones described with respect to process 600. For example, in one embodiment, process 600 implements a request-response protocol, in which it awaits a request received from an antenna peaking assistant, and responsive to the received request, transmits the signal strength information to the antenna peaking assistant.

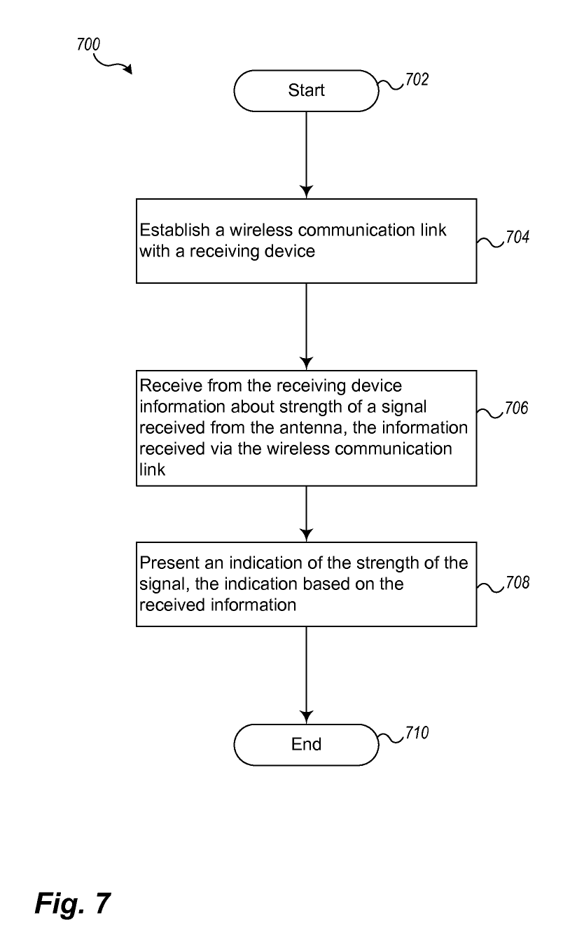

FIG. 7 is a flow diagram of an example antenna peaking assistant process provided by an example embodiment. In particular, FIG. 7 illustrates process 700 that may be implemented by, for example, one or more modules/components of the antenna peaking assistant 100, such as the peaking client logic 204, described with respect to FIGS. 2 and 4.

The illustrated process 700 starts at 702. At 704, the process establishes a wireless communication link with a receiving device. As discussed with respect to FIG. 2, establishing a wireless communication link may include establishing a network connection via a wireless personal or local area network, a voice/data channel of a cellular telephone network, or the like.

At 706, the process receives from the receiving device information about strength of a signal received from the antenna, the information received via the wireless communication link. As discussed with respect to FIG. 2, the transmitted information may be or include a number or some other indication of the determined signal strength.

At 708, the process presents an indication of the strength of the signal, the indication based on the received information. Various types of signal strength indicator are discussed with respect to FIGS. 3A and 3B, such as a graphics display, a numeric display, a speaker, one or more light sources, or the like. The process typically uses the signal strength indicator presents an indication that can be updated (e.g., made larger/smaller, longer/shorter, higher/lower, or the like) in response to changes in the received signal strength.

At 710, the process ends. In other embodiments, the process may instead continue to one of steps 704-708, in order to provide to receive and present updated information about the strength of the program signal received by the antenna.

Some embodiments perform one or more operations/aspects in addition to the ones described with respect to process 700. For example, in one embodiment, process 700 begins with an initial configuration/installation operation, in which a user obtains (e.g., downloads), installs, and/or configures antenna peaking logic on a hand-held computing device, such as a smart phone, remote-control, or PDA, so that the computing device can operate as an antenna peaking assistant.

While various embodiments have been described hereinabove, it is to be appreciated that various changes in form and detail may be made without departing from the spirit and scope of the invention(s) presently or hereafter claimed.

1. A system, comprising:
a set-top box that is communicatively coupled to an antenna;
a display that is communicatively coupled to the set-top box; and
a device having a signal strength indicator, the device being in a housing separate from the set-top box and the display and wirelessly communicatively coupled to the set-top box;
wherein the set-top box is configured to:
determine strength of a program signal received by the antenna; and
transmit information about the determined strength of the program signal to the device; and
wherein the device is configured to:
wirelessly receive the transmitted information about the determined strength of the program signal; and
present on the signal strength indicator an indication of the strength of the program signal, the presented indication based on the received information.

2. The system of claim 1 wherein the device is a smart phone, wherein the signal strength indicator includes a bit-mapped graphics display of the smart phone, and wherein the smart phone is configured to present the indication of the strength of the program signal by displaying the indication of the strength of the signal on the bit-mapped graphics display.

3. The system of claim 2 wherein the smart phone is configured to wirelessly receive the transmitted information via a cellular telephone network, and wherein the set-top box is further configured to:
initiate a telephone call over the cellular network to the smart phone; and
transmit the information via the cellular network to the smart phone.

4. The system of claim 1 wherein the set-top box is configured to initiate display, concurrently with the transmission of the information about the determined strength of the program signal, an indication of the strength of the program signal, the indication displayed upon the display.

5. The system of claim 1 wherein the device is a remote-control device, wherein the signal strength indicator includes a speaker and one or more lights of the remote-control device, and wherein the remote-control device is configured to present the indication of the strength of the program signal by outputting a tone via the speaker together with increasing brightness of the one or more lights.

6. A method in a receiving device for facilitating antenna configuration, the method comprising:
determining strength of a program signal received by an antenna communicatively coupled to a receiving device; and
causing an antenna peaking assistant to display an indication of the determined strength of the program signal by:
establishing a wireless communication link with the antenna peaking assistant; and
transmitting via the wireless communication link information about the determined strength of the program signal.

7. The method of claim 6 wherein determining the strength of the program signal includes measuring power of a signal received by a satellite antenna.

8. The method of claim 6 wherein determining the strength of the program signal includes measuring power of a signal received by an over-the-air antenna.

9. The method of claim 6 wherein establishing the wireless communication link with the antenna peaking assistant includes initiating a telephone call via a cellular telephone network to the antenna peaking assistant.

10. The method of claim 6 wherein establishing the wireless communication link with the antenna peaking assistant includes accepting, via a wireless local area network, a connection request from the antenna peaking assistant.

11. The method of claim 6, further comprising:
presenting, on a presentation device coupled to the receiving device, an indication of the determined strength of the program signal.

12. The method of claim 6, further comprising:
receiving from a smart phone a request for an antenna peaking software module; and
causing the smart phone to become the antenna peaking assistant by transmitting to the smart phone the antenna peaking software module, such that the smart phone can execute the antenna peaking software module.

13. A method in a hand-held computing device, the method comprising:
facilitating configuration of an antenna coupled to a receiving device, by:
establishing a wireless communication link with the receiving device;
receiving from the receiving device information about strength of a signal received from the antenna, the information received via the wireless communication link; and
presenting an indication of the strength of the signal, the indication based on the received information.

14. The method of claim 13 wherein the hand-held computing device includes a bitmapped graphics display, and wherein presenting the indication of the strength of the signal includes displaying a signal meter on the bitmapped graphics display.

15. The method of claim 13 wherein the hand-held computing device includes a speaker, and wherein presenting the indication of the strength of the signal includes increasing volume and/or frequency of a tone played through the speaker.

16. The method of claim 13 wherein the hand-held computing device includes one or more lights, and wherein presenting the indication of the strength of the signal includes increasing illumination of at least one of the one or more lights.

17. The method of claim 13 wherein establishing the wireless communication link with the receiving device includes initiating a telephone call to the receiving device via a cellular network.

18. The method of claim 13 wherein receiving information from the receiving device includes receiving the information via one or more of a wireless local area network, a WiMAX network, a wireless personal area network, and a Long Term Evolution network.

19. The method of claim 13, further comprising:
receiving an antenna peaking code module that is configured, when executed, to perform the method;
installing the antenna peaking code module; and
executing the antenna peaking code module.

20. The method of claim 19 wherein the antenna peaking code module is received from the receiving device.

21. The method of claim 13 wherein the information about the strength of the signal is received at a first time, and further comprising:
receiving from the receiving device additional information about strength of a signal received from the antenna at a second time that is later than the first time; and
updating, based on the additional information, the presented indication of the strength of the signal.
